(19) United States
(12) Patent Application Publication
(10) Pub. No.: US 2009/0216578 A1
(43) Pub. Date: Aug. 27, 2009

(54) COLLABORATIVE INNOVATION SYSTEM

(75) Inventors: Michael E. Bechtel, Naperville, IL (US); Sean R. Kampas, Hanover Park, IL (US)

Correspondence Address: ACCENTURE CHICAGO 28164;BRINKS HOFER GILSON & LIONE, P O BOX 10395, CHICAGO, IL, 60610, US

(73) Assignee: ACCENTURE GLOBAL SERVICES GMBH, Schaffhausen (CH)

(21) Appl. No.: 12/035,988

(22) Filed: Feb. 22, 2008

(51) Int. Cl. G06Q 99/00

(52) U.S. Cl. 705/7

(57) ABSTRACT

A collaborative innovation system is described. The system may include a memory, an interface, and a processor. The memory may store a topic, responses, revisions, and ratings. The interface may communicate with a content provider and users. The processor may receive the topic from the content provider and provide the topic to the users. The processor may receive responses from some of the users based on the topic. The processor may provide the received responses to all of the users. The processor may receive revisions to the responses from some of the users. The processor may provide the received revisions to all of the users. The processor may receive ratings of the responses and the revisions from the users. The processor may provide the responses and revisions to the content provider, ordered based on the ratings.

### TECHNICAL FIELD

The present description relates generally to a system and method, generally referred to as a system, for providing for collaborative innovation, and more particularly, but not exclusively, to providing for collaborative innovation where multiple innovation paths may stem from an initial item resulting in multiple innovation results.

### BACKGROUND

Collaborative systems may allow users to cooperatively build off an initial topic by structuring and restructuring the topic. The initial topic may continually evolve as additional users provide insight to the topic. The final result may be a representation of the group knowledge over a period of time. However, collaborative innovation systems may operate linearly. A linear collaborative innovation system may restrict innovation by dictating a linear progression of structuring and re-structuring the initial idea.

### SUMMARY

A system for providing a configurable adaptor for mediating systems may include a memory, an interface, and a processor. The memory may be connected to the processor and the interface and may store a topic, responses, revisions, and ratings. The interface may communicate with a content provider and users. The processor may receive the topic from the content provider and provide the topic to the users. The processor may receive responses from some of the users based on the topic. The processor may provide the received responses to all of the users. The processor may receive revisions to the responses from some of the users. The processor may provide the received revisions to all of the users. The processor may receive ratings of the responses and the revisions from the users. The processor may provide the responses and revisions to the content provider, ordered based on the ratings.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a collaborative innovation system.

FIG. 2 is a block diagram of a network environment implementing the system of FIG. 1 or other collaborative innovation systems.

FIG. 3 is an illustration of multiple innovation paths in the system of FIG. 1 or other collaborative innovation systems.

FIG. 4 is a flowchart illustrating the operations of the system of FIG. 1, or other collaborative innovation systems.

FIG. 5 is a flowchart illustrating the operations of multiple innovation iterations in the system of FIG. 1, or other collaborative innovation systems.

FIG. 6 is a flowchart illustrating the operations of a content provider in the system of FIG. 1, or other collaborative innovation systems.

FIG. 7 is an illustration of a general computer system that may be used in the systems of FIG. 2 or FIG. 3, or other collaborative innovation systems.

### DETAILED DESCRIPTION

A system and method, generally referred to as a system, may relate to providing for collaborative innovation, and more particularly, but not exclusively, providing for collaborative innovation where multiple innovation paths may stem from an initial item resulting in multiple innovation results. The principles described herein may be embodied in many different forms.

The system may be used to provide users with an unstructured collaborative innovation system. The system may allow users to control the flow and direction of the collaborative innovation. The system may allow users to create multiple parallel streams of innovation branching off of one initial item. The system may allow users to simultaneously innovate the initial item from multiple different perspectives. The system may allow for simultaneous innovation of incompatible perspectives of the initial idea. The system may provide a completely unrestricted collaboration environment which may maximize the users' innovation of an initial item. The results of the collaborative innovation may be multiple distinct innovations based on the initial item.

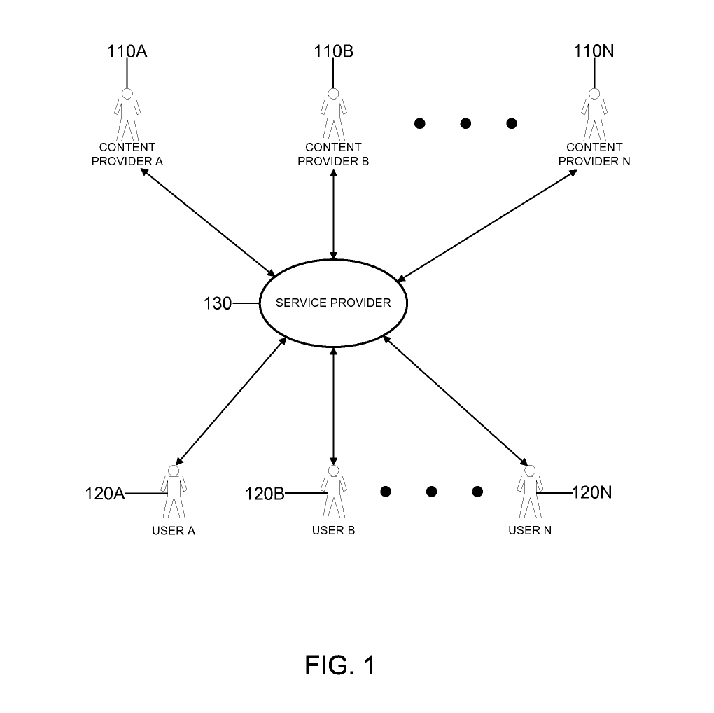

FIG. 1 provides a general overview of a collaborative innovation system 100. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more content providers 110A-N, such as any providers of content for review, a service provider 130, such as a collaborative innovation service provider, and one or more users 120A-N, such as any users in a collaborative environment. For example, in an organization the content providers 110A-N may be upper management, or decision makers within the organization while the users 120A-N may be employees of the organization. In another example, the content providers 110A-N may be administrators of an online collaborative web site, such as WIKIPEDIA, and the users 120A-N may be any web surfers providing knowledge to the collaborative website. The initial content, or item, may be any information capable of being responded to by the users 120A-N, such as a statement, a question, an image, a song, or a video. In the example of an organization, a content provider A 110A may provide a question as the initial item, such as a question of importance to the upper management of the organization.

The users 120A-N may provide responses to the initial item and responses to existing responses. A response to an existing response may be referred to as a revision. The users 120A-N may provide a revision to a response at any point in the innovation path. For example, the user A 120A may provide a response to the initial item, or the user A 120A may provide a revision to a response to the initial item. As the users 120A-N provide responses to existing responses, distinct parallel paths of innovation may emerge from the initial item. For example, there may be three responses to the initial item. The three responses may each have three responses of their own, and so on. The result of the collaborative innovation process may be conceptualized as a tree-like structure with the initial item as the root and multiple responses branching out from the initial item. The end of each of the parallel innovation paths may be distinct innovations based on the initial item. However, the end of the innovation path may not necessarily be the most valuable innovation derived from the process.

The users 120A-N may provide ratings of the responses of the other users 120A-N. The ratings may be indicative of whether the users 120A-N believe the response is accurate, or valuable, based on the initial item. For example, if the initial item is a question, the users 120A-N may rate the responses and the revisions to the responses based on which are the most accurate responses to the question. The service provider 130 may order the responses and revisions, based on the ratings, and provide an ordered list of responses to the content provider A 110A who provided the initial item. The content provider A 110A may be able to quickly review the highest rated responses and/or revisions and select the response and/or revision which is most accurate. The content provider A 110A may provide an indication of the most accurate response and/or revision to the service provider 130.

In operation one of the content providers 110A-N, such as the content provider A 110A may provide an item for review. The item may be a question whose answer is of value to the content provider A 110A. The content provider A 110A may identify a period of time that the question should be provided to the users 120A-N for innovation. The content provider A 110A may also identify a set of the users 120A-N that the question should be provided to. The content provider A 110A may select a set of the users 120A-N based on the demographics of the users 120A-N, or generally any characteristic of the users 120A-N capable of segmenting the users 120A-N. The users 120A-N may be required to provide demographic information when they first register for the system 100. In the case of an organization, the human resources department of the organization may have access to the demographic information of the users 120A-N.

The service provider 130 may provide the item to the users 120A-N for review and/or innovation. The users 120A-N may provide one or more responses to the item. In the case of a question, the users 120A-N may provide one or more answers to the question. The service provider 130 may receive the responses from the users and may provide the responses to all of the users 120A-N. The users 120A-N may provide responses to the responses and the service provider may provide the responses to the responses to the users 120A-N. For example, in the case of a question, the first level of responses may be answers to the questions. The second level of responses, in response to the first level of responses, may be modifications to the answers or more detail added to the answers. The users 120A-N may then provide a third level of responses, in response to the second level responses, which may be further revisions or details added to the second level of responses.

As the service provider 130 receives responses from a user A 120A, the service provider 130 may continue to provide the responses to the users 120A-N. The users 120A-N may continue to provide responses to other responses, or responses to the initial item throughout the innovation period. The users 120A-N may also provide ratings of any of the responses. The users 120A-N may rate any of the responses in the innovation paths. For example, the users 120A-N may rate a response with either “like,” or “don't like.” The “like” response may have a value of 1, while the “don't like” response may have a value of 0.

Once the innovation period indicated by the content provider A 110A has expired, the service provider 130 may stop providing the item, and the responses, to the users 120A-N. The service provider 130 may then calculate a total rating for each of the responses received from the users 120A-N. The total rating for a response may be a sum of the values of all the ratings the response received. For example, in the case of “like” and “don't like,” the service provider may add a 1 to the total rating of the response for every “like” the response received and a 0 to the total rating of the response for every “don't like” the response received. The service provider 130 may order the responses based on the total rating of each response. The service provider 130 may provide the ordered list of responses to the content provider A 110A. The ordered list may allow the content provider A 110A to quickly and efficiently determine the most valuable responses, or innovations, to arise from the innovation period. The content provider A 110A may select one or more responses as the most valuable responses and may provide an indication of the most valuable responses to the service provider 130.

Alternatively or in addition the service provider 130 may provide reports the users 120A-N and/or the content providers 110A-N. The reports may display data related to the activity of the users 120A-N. Alternatively or in addition the reports may summarize the items provided to the system 100 for innovation and the responses that were selected by the content providers 110A-N for each item.

One or more of the users 120A-N and/or the content providers 110A-N may be an administrator of the system 100. An administrator may be generally responsible for maintaining the system 100 and may be responsible for maintaining the permissions of the users 120A-N and the content providers 11 OA-N. The administrator may need to approve of any new users 120A-N in the system 100 before the users 120A-N are allowed to provide responses and ratings to the system 100.

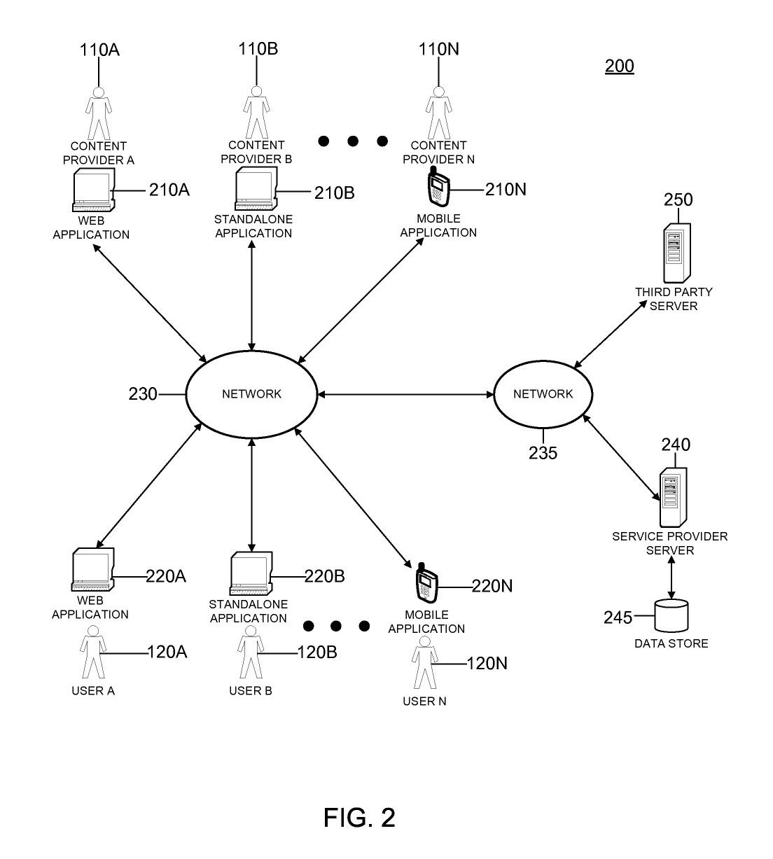

FIG. 2 provides a view of a network environment 200 implementing the system of FIG. 1 or other collaborative innovation systems. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The network environment 200 may include one or more web applications, standalone applications and mobile applications 210A-N, which may be client applications of the content providers 110A-N. The system 200 may also include one or more web applications, standalone applications, mobile applications 220A-N, which may be client applications of the users 120A-N. The web applications, standalone applications and mobile applications 210A-N, 220A-N, may collectively be referred to as client applications 210A-N, 220A-N. The system 200 may also include a network 230, a network 235, the service provider server 240, a data store 245, and a third party server 250.

Some or all of the service provider server 240 and third-party server 250 may be in communication with each other by way of network 235. The third-party server 250 and service provider server 240 may each represent multiple linked computing devices. Multiple distinct third party servers, such as the third-party server 250, may be included in the network environment 200. A portion or all of the third-party server 250 may be a part of the service provider server 240.

The data store 245 may be operative to store data, such as user information, initial items, responses from the users 120A-N, ratings by the users 120A-N, user response quality scores, or generally any data that may need to be stored in a data store 245. The data store 245 may include one or more relational databases or other data stores that may be managed using various known database management techniques, such as SQL and object-based techniques. Alternatively or in addition the data store 245 may be implemented using one or more of the magnetic, optical, solid state or tape drives. The data store 245 may be in direct communication with the service provider server 240. Alternatively or in addition the data store 245 may be in communication with the service provider server 240 through the network 235.

The networks 230, 235 may include wide area networks (WAN), such as the internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet.

The content providers 110A-N may use a web application 210A, standalone application 210B, or a mobile application 210N, or any combination thereof, to communicate to the service provider server 240, such as via the networks 230, 235. Similarly, the users 120A-N may use a web application 220A, a standalone application 220B, or a mobile application 220N to communicate to the service provider server 240, via the networks 230, 235.

The service provider server 240 may provide user interfaces to the content providers 110A-N via the networks 230, 235. The user interfaces of the content providers 110A-N may be accessible through the web applications, standalone applications or mobile applications 210A-N. The service provider server 240 may also provide user interfaces to the users 120A-N via the networks 230, 235. The user interfaces of the users 120A-N may also be accessible through the web applications, standalone applications or mobile applications 220A-N. The user interfaces may be designed using ADOBE FLEX. The user interfaces may be initially downloaded when the applications 210A-N, 220A-N first communicate with the service provider server 240. The client applications 210A-N, 220A-N may download all of the code necessary to implement the user interfaces, but none of the actual data. The data may be downloaded from the service provider server 240 as needed. The user interfaces may be developed using the singleton development pattern, utilizing the model locator found within the cairngorm framework. Within the singleton pattern there may be several data structures each with a corresponding data access object. The data structures may be structured to receive the information from the service provider server 240.

The user interfaces of the content providers 110A-N may be operative to allow a content provider A 110A to provide an initial item, and allow the content provider A 110A to specify a period of time for review of the item. The user interfaces of the users 120A-N may be operative to display the initial item to the users 120A-N, allow the users 120A-N to provide responses and ratings, and display the responses and ratings to the other users 120A-N. The user interfaces of the content providers 110A-N may be further operative to display the ordered list of responses to the content provider A 110A and allow the content provider to provide an indication of the selected response.

The web applications, standalone applications and mobile applications 210A-N, 220A-N may be connected to the network 230 in any configuration that supports data transfer. This may include a data connection to the network 230 that may be wired or wireless. The web applications 210A, 220A may run on any platform that supports web content, such as a web browser or a computer, a mobile phone, personal digital assistant (PDA), pager, network-enabled television, digital video recorder, such as TIVO®, automobile and/or any appliance capable of data communications.

The standalone applications 210B, 220B may run on a machine that may have a processor, memory, a display, a user interface and a communication interface. The processor may be operatively connected to the memory, display and the interfaces and may perform tasks at the request of the standalone applications 210B, 220B or the underlying operating system. The memory may be capable of storing data. The display may be operatively connected to the memory and the processor and may be capable of displaying information to the content provider B 110B or the user B 120B. The user interface may be operatively connected to the memory, the processor, and the display and may be capable of interacting with a user B 120B or a content provider B 110B. The communication interface may be operatively connected to the memory, and the processor, and may be capable of communicating through the networks 230, 235 with the service provider server 240, and the third party server 250. The standalone applications 210B, 220B may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, ADOBE FLEX, and PHP, amongst others.

The mobile applications 210N, 220N may run on any mobile device that may have a data connection. The data connection may be a cellular connection, a wireless data connection, an internet connection, an infra-red connection, a Bluetooth connection, or any other connection capable of transmitting data.

The service provider server 240 may include one or more of the following: an application server, a data store, such as the data store 245, a database server, and a middleware server. The application server may be a dynamic HTML server, such as using ASP, JSP, PHP, or other technologies. The service provider server 240 may co-exist on one machine or may be running in a distributed configuration on one or more machines. The service provider server 240 may collectively be referred to as the server. The service provider server 240 may implement a server side Wiki engine, such as ATLASSIAN CONFLUENCE. The service provider server 240 may receive requests from the users 120A-N and the content providers 110A-N and may provide data to the users 120A-N and the content providers 110A-N based on their requests. The service provider server 240 may communicate with the client applications 210A-N, 220A-N using extensible markup language (XML) messages.

The third party server 250 may include one or more of the following: an application server, a data source, such as a database server, and a middleware server. The third party server may implement any third party application that may be used in a collaborative innovation system, such as a user verification system. The third party server 250 may co-exist on one machine or may be running in a distributed configuration on one or more machines. The third party server 250 may receive requests from the users 120A-N and the content providers 110A-N and may provide data to the users 120A-N and the content providers 110A-N based on their requests.

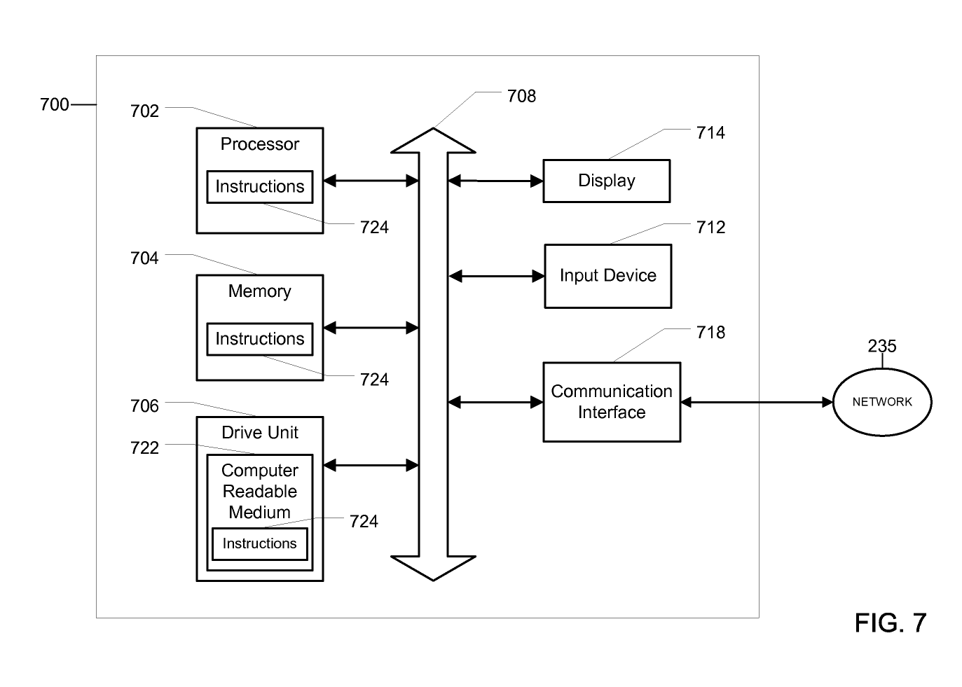

The service provider server 240 and the third party server 250 may be one or more computing devices of various kinds, such as the computing device in FIG. 7. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web applications 210A, 210A may employ HTTP to request information, such as a web page, from a web server, which may be a process executing on the service provider server 240 or the third-party server 250.

There may be several configurations of database servers, such as the data store 245, application servers, and middleware servers included in the service provider server 240, or the third party server 250. Database servers may include MICROSOFT SQL SERVER®, ORACLE®, IBM DB2® or any other database software, relational or otherwise. The application server may be APACHE TOMCAT®, MICROSOFT IIS®, ADOBE COLDFUSION®, or any other application server that supports communication protocols. The middleware server may be any middleware that connects software components or applications.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

In operation the client applications 210A-N, 220A-N may make requests back to the service provider server 240. The service provider server 240 may access the data store 245 and retrieve information in accordance with the request. The information may be formatted as XML and communicated to the client applications 210A-N, 220A-N. The client applications 210A-N, 220A-N may display the XML appropriately to the users 120A-N, and/or the content providers 110A-N.

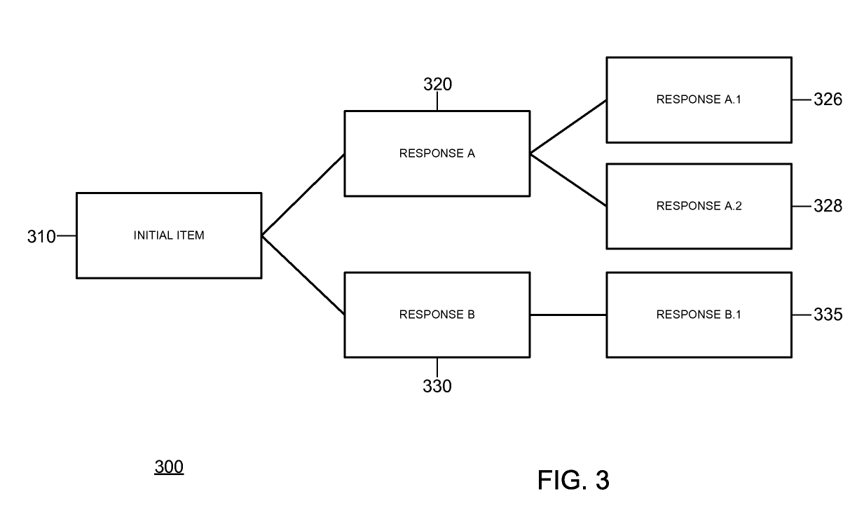

FIG. 3 is an illustration 300 of multiple innovation paths in the system of FIG. 1 or other collaborative innovation systems. The illustration 300 includes an initial item 310, a response A 320, a response B 330, a response A.1 326, a response A.2 328, and a response B.1 335. The illustration 300 may demonstrate the multiple parallel paths of innovation that may be innovated by the users 120A-N in the system 100.

In operation the content provider A 110A may provide the initial item 310 to the users 120A-N. The user A 120A may provide the response A 320 in response to the initial item 310, and the user B 120B may provide the response B 330 in response to the initial item 310. The response A 320 and the response B 330 may be adverse to one another, but individually may be plausible responses to the initial item 310. The user A 120A may provide the response B.1 335 in response to the response B 330 provided by the user B 120B. While the response B 330 may be adverse to the response A 320, the user A 120A may innovate off of the response B 330B in the form of the response B.1 335.

The user B 120B may provide the response A.1 326 in response to the response A 320, and the user N 120N may provide the response A.2 328 in response to the response A 320. The users 120A-N may continue to add levels of responses beyond the responses 326, 328, 335 throughout the innovation period. The users 120A-N may also rate any of the responses 320, 330, 326, 328, 335. For example, the user A 120A may rate the response B 330 as the best response to the initial item 310, even though it is not the last response in the innovation path. Alternatively or in addition the user B 120B may rate the response A.1 326 as the best response to the initial item 310. The users 120A-N may select one item as the best item, may rate the items on a scale, such as one to ten, or may rate the items as “like” or “don't like.”

Once the innovation period has ended the total ratings of the responses may be determined and the responses may be ordered based on the total ratings. The ordered responses may be provided to the content provider A 110A who provided the initial item 310. The responses with the highest ratings will be the responses at the top of the list. If the users 120A-N believed multiple responses were good responses for the item, the multiple responses may appear at the top of the ordered list with high ratings. The content provider A 110A may select one or more responses as the most valuable responses. The content provider A 110A may provide an indication of the most valuable responses to the service provider 130.

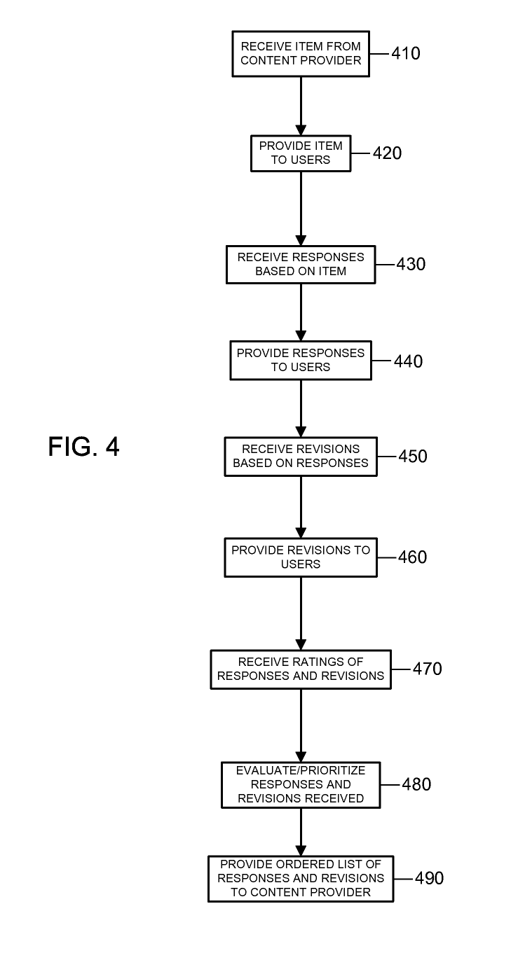

FIG. 4 is a flowchart illustrating the operations of the system of FIG. 1, or other collaborative innovation systems. At block 410 the service provider 130 may receive an item from the content provider A 110A for innovation and/or review. For example the item may be a question whose answer is of value to the content provider A 110A. Alternatively or in addition the item may be a topic of value to the content provider A 110A. The content provider A 110A may also specify an innovation period. The innovation period may be the period of time the item should be provided to the users 120A-N for innovation. At block 420 the service provider 130 may provide the item to the users 120A-N, such as by displaying the item to the users 120A-N. At block 430 the service provider 130 may receive responses from the users 120A-N based on the item. For example, if the item is a question, the users 120A-N may provide possible answers to the question.

At block 440 the service provider 130 may provide the responses to the users 120A-N, such as by displaying the responses to the users 120A-N. At block 450 the service provider 130 may receive responses, or revisions, from the users 120A-N based on the responses. The revisions to the responses may be enhancements to the responses, may provide additional detail to the responses or may clarify the responses. At block 460 the service provider 130 may provide the revisions to the users 120A-N, such as by displaying the revisions to the users 120A-N. At block 470 the service provider 130 may receive ratings of the responses and revisions from the users 120A-N. The ratings may indicate whether the users 120A-N believe a response or revision is accurate for the initial item. Alternatively or in addition the ratings may indicate whether the users 120A-N believe a response or revision is a valuable innovation of the initial idea.

At block 480 the service provider 130 may evaluate and prioritize the responses and revisions received. The responses and revisions may be ordered based on the ratings received for the revisions and responses. At block 490 the service provider 130 may provide the ordered list of responses and revisions to the content provider A 110A who provided the initial item. The ordered list of responses and revisions may allow the content provider A 110A to quickly and efficiently determine the most valuable and/or accurate responses.

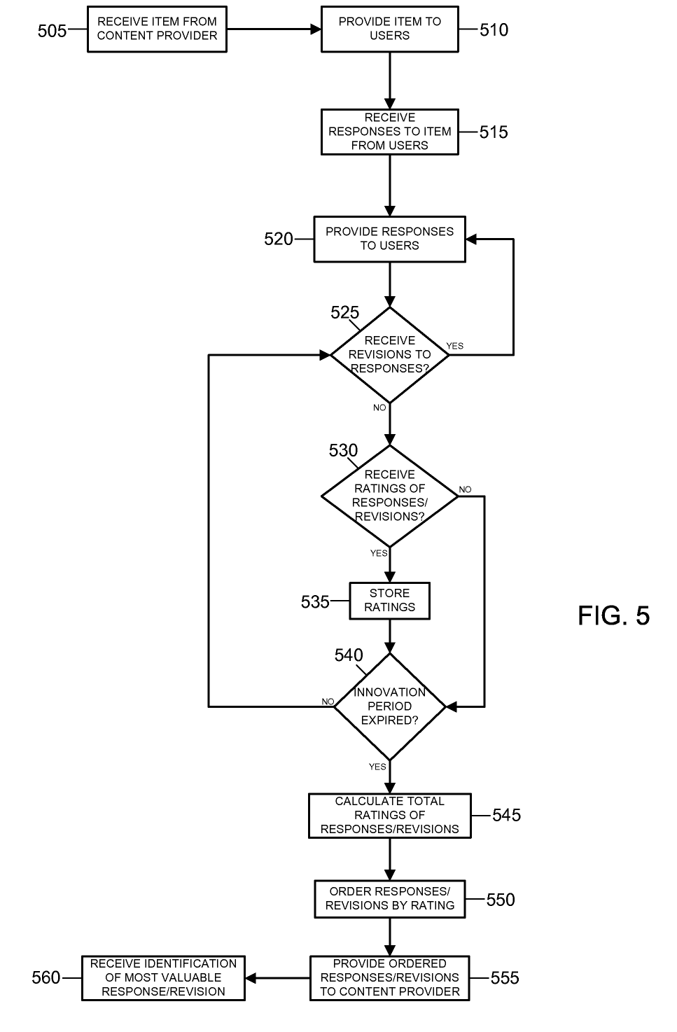

FIG. 5 is a flowchart illustrating the operations of the innovation iterations in the system of FIG. 1, or other collaborative innovation systems. At block 505 the service provider 130 may receive an item from the content provider A 110A for innovation and/or review. For example the item may be a question whose answer is of value to the content provider A 110A. Alternatively or in addition the item may be a topic of value to the content provider A 110A. The content provider A 110A may also specify an innovation period. The innovation period may be the period of time the item should be provided to the users 120A-N for innovation. The content provider A 110A may also identify a subset of the users 120A-N the item should be provided to, such as users 120A-N of a particular demographic.

At block 510 the service provider 130 may provide the item to the users 120A-N, such as by displaying the item to the users 120A-N. The users 120A-N may be notified that the item is available, such as via an email notification. At block 515 the service provider 130 may receive responses from the users 120A-N based on the item. For example, if the item is a question, the users 120A-N may provide possible answers to the question. At block 520 the service provider 130 may provide the responses to the users 120A-N, such as by displaying the responses to the users 120A-N.

At block 525 the system 100 may determine whether the service provider 130 received any responses, or revisions, to the responses from the users 120A-N. The revisions may be enhancements to the responses, may provide additional detail to the responses, or may clarify the responses. If at block 525 the service provider 130 receives a response to one of the responses, the system 100 may return to block 520 where the response is provided to the users 120A-N, such as by displaying the response to the users 120A-N. By continually providing new responses to the users 120A-N, the system 100 may cultivate multiple paths of innovation stemming from the initial item provided by the content provider A 110A.

The service provider 130 may store the responses and/or revisions received from the users 120A-N in the data store 245. The service provider 130 may store the response, the response or item the response was based on, or associated with, an association between the response and the item or response the response was based on or associated with, the user A 120A who provided the response, and the date/time the response was provided.

If at block 525 the service provider 130 does not receive an additional response the system 100 may move to block 530. At block 530 the system 100 may determine whether the service provider 130 received any ratings of the responses and/or revisions. If at block 530 the service provider 130 receives a rating the system 100 may move to block 535. At block 535 the service provider 130 may store the rating in the data store 245. The service provider 130 may store the response being rated, the value of the rating provided, data describing the user A 120A who provided the rating, data describing the user B 120B who provided the response that was rated, and the date/time the rating was provided.

If at block 530 the service provider 130 does not receive any ratings of the responses and/or revisions, the system 100 may move to block 540. At block 540 the service provider 130 may determine whether the innovation period identified by the content provider A 110A expired. If the innovation period identified by the content provider A 110A has not expired, the system 100 may return to block 525 and continue to wait for responses and/or ratings. If at block 540 the innovation period has expired, the system 100 may move to block 545.

At block 545 the service provider 130 may calculate the total rating of each response and/or revision. The total rating of each response and/or revision may be calculated by adding the values of each rating the responses and/or revisions received. At block 550 the system 100 may order the responses and/or revisions in accordance with the total rating the responses and/or revisions received. At block 555 the service provider 130 may provide the ordered list of responses and/or revisions to the content provider A 110A who provided the initial item. The ordered list of responses and/or revisions may allow the content provider A 110A to quickly and efficiently determine the valuable and/or accurate responses and/or revisions. At block 560 the service provider 130 may receive an indication of one or more most valuable responses and/or revisions from the content provider A 110A. The most valuable responses and/or revisions may be the responses and/or revisions that are provide the most accurate response to the initial item, or the responses and/or revisions that provide the best innovation of the initial item.

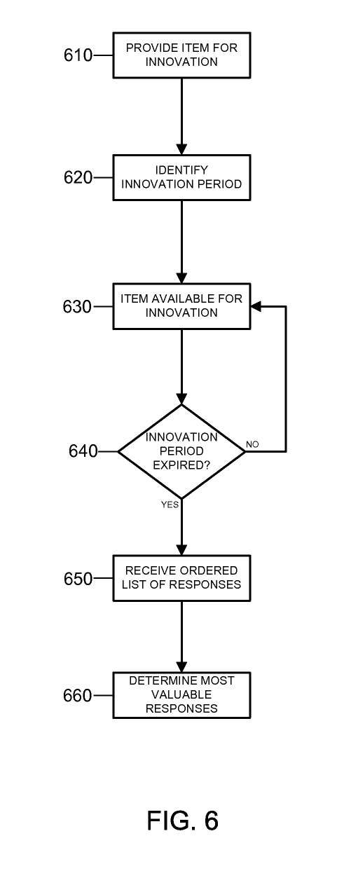

FIG. 6 is a flowchart illustrating the operations of a content provider in the system of FIG. 1, or other collaborative innovation systems. At block 610 the content provider A 110A may provide an item to the service provider 130 for innovation or review. The item may be a question, a statement, an idea, a news topic, an audio clip, a video clip, or generally any item that may be a catalyst for innovation. At block 620 the content provider A 110A may specify an innovation period for the item. The innovation period may be the period of time the item should be provided to the users 120A-N for innovation. Alternatively or in addition the content provider A 110A may identify a subset of the users 120A-N the item should be provided to, such as users 120A-N of a particular demographic.

At block 630 the item may be available to the users 120A-N for innovation. The content providers 110A-N may also participate in the innovation period by providing responses and/or ratings. At block 640 the system 100 may determine whether the innovation period has expired. If the innovation period has not expired, the system 100 may return to block 630 where the item is kept available for review. If at block 640 the innovation period has expired, the system 100 may move to block 650.

At block 650 the content provider A 110A may receive an ordered list of the responses. The responses may be ordered based on the ratings the responses received from the users 120A-N. The ratings of the responses may represent the value the users 120A-N perceived in the responses. The content provider A 110A may be able to quickly and efficiently determine the most valuable responses by focusing their review on the responses with the highest ratings. At block 660 the content provider A 110A may determine one or more most valuable responses. The most valuable response may be the most economically valuable, the most intellectually valuable, or generally the response most valuable to the content provider A 110A. The content provider A 110A may send an indication of the most valuable response to the service provider 130. The service provider 130 may reward the user A 120A if a response of the user A 120A is selected by one of the content providers 110A-N.

FIG. 7 illustrates a general computer system 700, which may represent a service provider server 240, a third party server 250, the client applications 210A-N, 220A-N, or any of the other computing devices referenced herein. The computer system 700 may include a set of instructions 724 that may be executed to cause the computer system 700 to perform any one or more of the methods or computer based functions disclosed herein. The computer system 700 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 724 (sequential or otherwise) that specify actions to be taken by that machine. In a particular embodiment, the computer system 700 may be implemented using electronic devices that provide voice, video or data communication. Further, while a single computer system 700 may be illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, such as, a central processing unit (CPU), a graphics processing unit (GPU), or both. The processor 702 may be a component in a variety of systems. For example, the processor 702 may be part of a standard personal computer or a workstation. The processor 702 may be one or more general processors, digital signal processors, application specific integrated circuits, field programmable gate arrays, servers, networks, digital circuits, analog circuits, combinations thereof, or other now known or later developed devices for analyzing and processing data. The processor 702 may implement a software program, such as code generated manually (i.e., programmed).

The computer system 700 may include a memory 704 that can communicate via a bus 708. The memory 704 may be a main memory, a static memory, or a dynamic memory. The memory 704 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 704 may include a cache or random access memory for the processor 702. Alternatively or in addition, the memory 704 may be separate from the processor 702, such as a cache memory of a processor, the system memory, or other memory. The memory 704 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 704 may be operable to store instructions 724 executable by the processor 702. The functions, acts or tasks illustrated in the figures or described herein may be performed by the programmed processor 702 executing the instructions 724 stored in the memory 704. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 700 may further include a display 714, such as a liquid crystal display (LCD), an organic light emitting diode (OLED), a flat panel display, a solid state display, a cathode ray tube (CRT), a projector, a printer or other now known or later developed display device for outputting determined information. The display 714 may act as an interface for the user to see the functioning of the processor 702, or specifically as an interface with the software stored in the memory 704 or in the drive unit 706.

Additionally, the computer system 700 may include an input device 712 configured to allow a user to interact with any of the components of system 700. The input device 712 may be a number pad, a keyboard, or a cursor control device, such as a mouse, or a joystick, touch screen display, remote control or any other device operative to interact with the system 700.

The computer system 700 may also include a disk or optical drive unit 706. The disk drive unit 706 may include a computer-readable medium 722 in which one or more sets of instructions 724, e.g. software, can be embedded. Further, the instructions 724 may perform one or more of the methods or logic as described herein. The instructions 724 may reside completely, or at least partially, within the memory 704 and/or within the processor 702 during execution by the computer system 700. The memory 704 and the processor 702 also may include computer-readable media as discussed above.

The present disclosure contemplates a computer-readable medium 722 that includes instructions 724 or receives and executes instructions 724 responsive to a propagated signal; so that a device connected to a network 235 may communicate voice, video, audio, images or any other data over the network 235. Further, the instructions 724 may be transmitted or received over the network 235 via a communication interface 718. The communication interface 718 may be a part of the processor 702 or may be a separate component. The communication interface 718 may be created in software or may be a physical connection in hardware. The communication interface 718 may be configured to connect with a network 235, external media, the display 714, or any other components in system 700, or combinations thereof. The connection with the network 235 may be a physical connection, such as a wired Ethernet connection or may be established wirelessly as discussed below. Likewise, the additional connections with other components of the system 700 may be physical connections or may be established wirelessly. In the case of a service provider server 240 or the content provider servers 110A-N, the servers may communicate with users 120A-N through the communication interface 718.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 722 may be a single medium, or the computer-readable medium 722 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 722 may include a solid-state memory such as a memory card or other package that houses one or more non-volatile read-only memories. The computer-readable medium 722 also may be a random access memory or other volatile re-writable memory. Additionally, the computer-readable medium 722 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method for collaborative innovation, the method comprising:
providing a topic received from a content provider to a plurality of users;
receiving a plurality of responses from the plurality of users based on the topic;
providing the plurality of responses to the plurality of users;
receiving a plurality of revisions to the plurality of responses from the plurality of users;
providing the plurality of revisions to the plurality of users;
receiving a plurality of ratings of the plurality of responses and the plurality of revisions from the plurality of users; and
providing the plurality of responses and the plurality of revisions to the content provider, wherein the plurality of responses and the plurality of revisions are ordered in accordance with the plurality of ratings.

2. The method of claim 1 wherein the topic comprises a question.

3. The method of claim 2 wherein at least one of the responses comprises an answer to the question.

4. The method of claim 1 further comprising receiving a plurality of secondary revisions to the plurality of revisions.

5. The method of claim 4 further comprising receiving a plurality of secondary ratings of the plurality of secondary revisions.

6. The method of claim 5 further comprising providing the plurality of secondary revisions to the content provider, wherein the secondary revisions are ordered in accordance with the plurality of secondary ratings.

7. A method for collaborative innovation, the method comprising:
providing an item received from a content provider to a plurality of users for review;
receiving a plurality of first level responses from the plurality of users based on the item;
providing the plurality of first level responses to the plurality of users for review;
receiving a plurality of second level responses from the plurality of users based on the item and one of the first level responses;
providing the plurality of second level responses to the plurality of users for review;
receiving a plurality of ratings of the plurality of first and second level responses from the plurality of users; and
providing the plurality of first and second level responses to the content provider, wherein the plurality of first and second level responses are ordered in accordance with the plurality of ratings.

8. The method of claim 7 further comprising:
receiving a plurality of third level responses from the plurality of users based on the item, one of the first level responses, and one of the second level responses;
providing the third level responses to the plurality of users for review;
receiving a plurality of ratings of the plurality of first, second and third level responses from the plurality of users; and
providing the plurality of first, second, and third level responses to the content provider wherein the plurality of first, second, and third level responses are ordered in accordance with the plurality of ratings.

9. The method of claim 7 further comprising:
receiving a plurality of N level responses from the plurality of users based on the item, one of the N-1 level responses, wherein N is any number;
providing the N level responses to the plurality of users for review;
receiving a plurality of ratings of the plurality of N level responses from the plurality of users; and
providing the plurality of first to N level responses to the content provider wherein the plurality of first to N level responses are ordered in accordance with the plurality of ratings.

10. The method of claim 7 wherein the plurality of ratings of a response indicates whether the plurality of users believes the response is accurate for the item.

11. A system for collaborative innovation, the system comprising:
means for providing a topic received from a content provider to a plurality of users;
means for receiving a plurality of responses from the plurality of users based on the topic;
means for providing the plurality of responses to the plurality of users;
means for receiving a plurality of revisions to the plurality of responses from the plurality of users;
means for providing the plurality of revisions to the plurality of users;
means for receiving a plurality of ratings of the plurality of responses and the plurality of revisions from the plurality of users; and
means for providing the plurality of responses and the plurality of revisions to the content provider, wherein the plurality of responses and the plurality of revisions are ordered in accordance with the plurality of ratings.

12. The system of claim 11 wherein the topic comprises a question.

13. The system of claim 12 wherein at least one of the responses comprises an answer to the question.

14. The system of claim 11 further comprising means for receiving a plurality of secondary revisions to the plurality of revisions.

15. The system of claim 14 further comprising means for receiving a plurality of secondary ratings of the plurality of secondary revisions.

16. The system of claim 15 further comprising means for providing the plurality of secondary revisions to the content provider, wherein the secondary revisions are ordered in accordance with the plurality of secondary ratings.

17. A method for collaborative innovation, the method comprising:
providing an item received from a content provider to a plurality of users for review;
receiving a plurality of responses from the plurality of users based on the item;
providing the plurality of responses to the plurality of users for review;
receiving a plurality of ratings of the plurality of responses from the plurality of users; and
providing the plurality of responses to the content provider, wherein the plurality of responses are ordered in accordance with the plurality of ratings.

18. A system for collaborative innovation, the system comprising:
a memory to store a topic, a plurality of responses, a plurality of revisions, and a plurality of ratings;
an interface operatively connected to the memory, the interface operative to communicate with a plurality of users and a content provider; and
a processor operatively connected to the memory and the interface, the processor operative to receive the topic from the content provider, provide the topic to the plurality of users, receive the plurality of responses from the plurality of users based on the topic, provide the plurality of responses to the plurality of users, receive a plurality of revisions to the plurality of responses from the plurality of users, provide the plurality of revisions to the plurality of users, receive a plurality of ratings of the plurality of responses and the plurality of revisions from the plurality of users, and provide the plurality of responses and the plurality of revisions to the content provider, wherein the plurality of responses and the plurality of revisions are ordered in accordance with the plurality of ratings.

21. The system of claim 20 wherein the topic comprises a question.

22. The system of claim 21 wherein at least one of the responses comprises an answer to the question.

23. The system of claim 20 wherein the processor is further operative to receive a plurality of secondary revisions to the plurality of revisions.

24. The system of claim 23 wherein the processor is further operative to receive a plurality of secondary ratings of the plurality of secondary revisions from the plurality of users.

25. The system of claim 24 wherein the processor is further operative to provide the plurality of secondary revisions to the content provider, wherein the secondary revisions are ordered in accordance with the plurality of secondary ratings.
